(19) United States
(12) Patent Application Publication
(10) Pub. No.: US 2025/0278351 A1
(43) Pub. Date: Sep. 4, 2025

(54) VALIDATION OF A SOFTWARE DOCUMENT

(71) Applicant: International Business Machines Corporation, Armonk, NY (US)

(72) Inventors: Abdulhamid Adebowale Adebayo, White Plains, NY (US); Andrew John Anderson, Stamford, CT (US); Neil Delima, Scarborough (CA); William Anderson, Cary, NC (US)

(21) Appl. No.: 18/591,510

(22) Filed: Feb. 29, 2024

(51) Int. Cl. G06F 11/36; G06F 8/77

(52) U.S. Cl. CPC G06F 11/3616; G06F 8/77

(57) ABSTRACT

A computer-implemented method (CIM), according to one embodiment, includes validating code blocks in a software document by performing a first validation process. The first validation process includes iterating through lines in the software document to identify the code blocks, extracting the identified code blocks, and determining an amount of a codebase that the code blocks cover, where the codebase is associated with the software document. The first validation process further includes executing the code blocks, and determining whether the code blocks execute correctly. The method further includes generating a report characterizing the software document. The report includes a project coverage metric that indicates the amount of the codebase that the code blocks cover, and an instruction validity metric that indicates an amount of the code blocks that executed correctly during execution of the code blocks. The instruction validity metric is based on a validation of the code blocks.

### BACKGROUND

The present invention relates to software development, and more specifically, this invention relates to software documentation.

Software documentation is an important part of the process of developing software. Software documentation provides records of the development process, as well as guides on how to complete basic tasks such as installation, usage with examples, and troubleshooting. Documentation is expected to be a living document that is updated over the course of a project. This documentation may be used for administrative purposes in the documentation of a project roadmap, a development team and contributors, meeting cadence and notes, etc. Furthermore, software documentation may be used for developer purposes such as for the documentation of code changes, feature updates, data flows and components, etc. Yet furthermore, software documentation may be used for user purposes such as providing basic instructions on installation, providing details on how a product is to be used, troubleshooting, etc.

### SUMMARY

A computer-implemented method (CIM), according to one embodiment, includes validating code blocks in a software document by performing a first validation process. The first validation process includes iterating through lines in the software document to identify the code blocks, extracting the identified code blocks, and determining an amount of a codebase that the code blocks cover, where the codebase is associated with the software document. The first validation process further includes executing the code blocks, and determining whether the code blocks execute correctly. The method further includes generating a report characterizing the software document. The report includes a project coverage metric that indicates the amount of the codebase that the code blocks cover, and an instruction validity metric that indicates an amount of the code blocks that executed correctly during execution of the code blocks. The instruction validity metric is based on a validation of the code blocks.

A computer program product (CPP), according to another embodiment, includes a set of one or more computer-readable storage media, and program instructions, collectively stored in the set of one or more storage media, for causing a processor set to perform the foregoing method.

A computer system (CS), according to another embodiment, includes a processor set, a set of one or more computer-readable storage media, and program instructions, collectively stored in the set of one or more storage media, for causing the processor set to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2 is a flowchart of a method, in accordance with one embodiment of the present invention.

FIG. 3 is a generated report, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for validation of a software document.

In one general embodiment, a CIM includes validating code blocks in a software document by performing a first validation process. The first validation process includes iterating through lines in the software document to identify the code blocks, extracting the identified code blocks, and determining an amount of a codebase that the code blocks cover, where the codebase is associated with the software document. The first validation process further includes executing the code blocks, and determining whether the code blocks execute correctly. The method further includes generating a report characterizing the software document. The report includes a project coverage metric that indicates the amount of the codebase that the code blocks cover, and an instruction validity metric that indicates an amount of the code blocks that executed correctly during execution of the code blocks. The instruction validity metric is based on a validation of the code blocks.

In another general embodiment, a CPP includes a set of one or more computer-readable storage media, and program instructions, collectively stored in the set of one or more storage media, for causing a processor set to perform the foregoing method.

In another general embodiment, a CS includes a processor set, a set of one or more computer-readable storage media, and program instructions, collectively stored in the set of one or more storage media, for causing the processor set to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as software document validation code of block 150 for validation of a software document. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

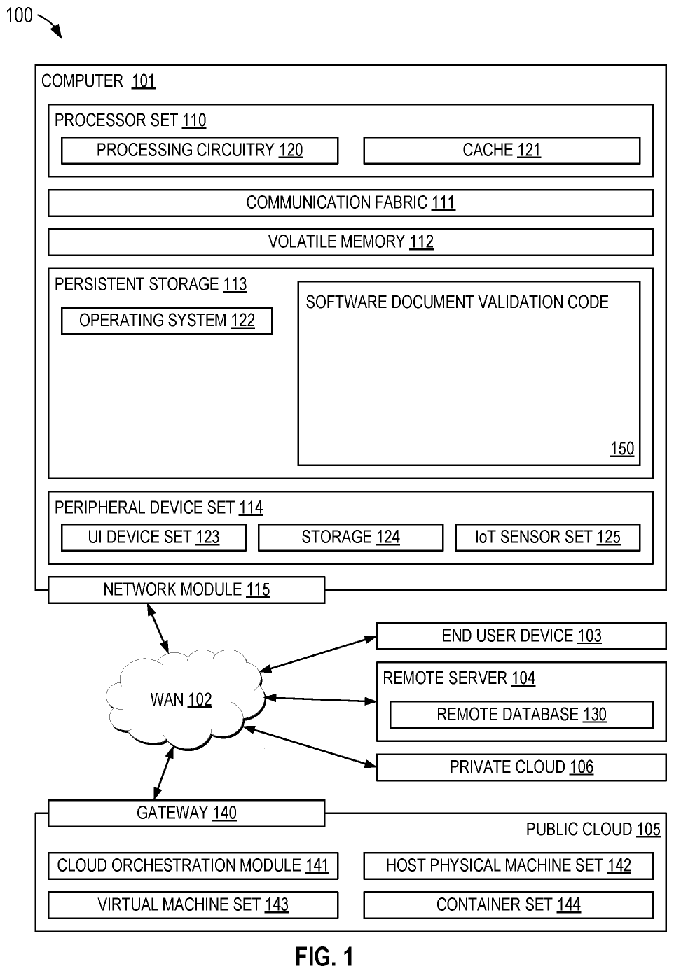

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

As mentioned elsewhere above, software documentation is an important part of the process of developing software. Software documentation provides records of the development process, as well as guides on how to complete basic tasks such as installation, usage with examples, and troubleshooting. Documentation is expected to be a living document that is updated over the course of a project. This documentation may be used for administrative purposes in the documentation of a project roadmap, a development team and contributors, meeting cadence and notes, etc. Furthermore, software documentation may be used for developer purposes such as for the documentation of code changes, feature updates, data flows and components, etc. Yet furthermore, software documentation may be used for user purposes such as providing basic instructions on installation, providing details on how a product is to be used, troubleshooting, etc.

Conventional software documentation techniques lack adequate documentation practices and thereby lead to unclear and outdated instructions. Some conventional projects have accurate documentation but do not coincide with working instructions and/or failing commands and/or include out-of-sequence instructions. Accordingly, use of conventional software documentation results in relatively high amounts of computer troubleshooting operations in order to sort through unclear and outdated instructions. In sharp contrast to these deficiencies, the techniques of embodiments and approaches described herein enable of documentation efficiencies by integrating an automated validation and testing mechanism for which existing documentation is measured in terms of a plurality of predetermined factors, e.g., such as ease of understanding, project coverage, and accuracy. Accordingly, the techniques described herein relatively reduce a considerable amount of troubleshooting operations that would otherwise be performed by each computer device that use software documents not validated and tested using the techniques described herein.

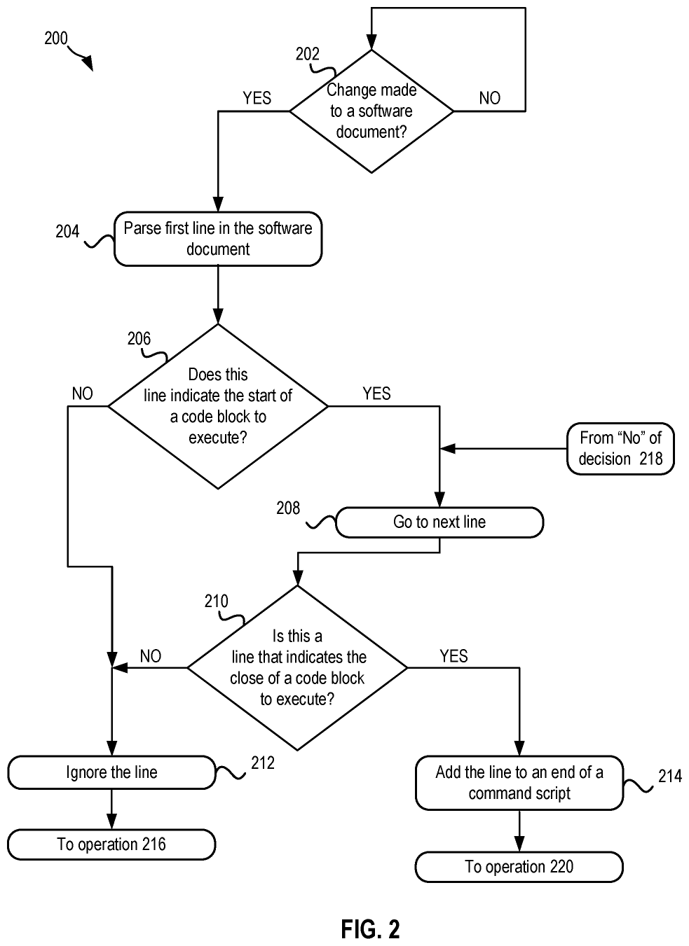

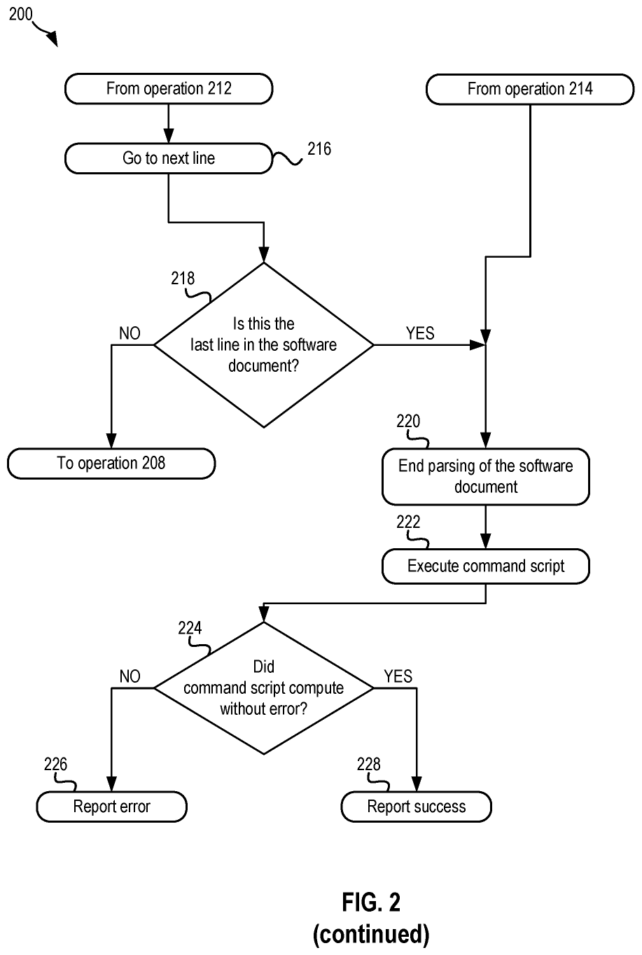

Now referring to FIG. 2, a flowchart of a method 200 is shown according to one embodiment. The method 200 may be performed in accordance with the present invention in any of the environments depicted in FIGS. 1-3, among others, in various embodiments. Of course, more or fewer operations than those specifically described in FIG. 2 may be included in method 200, as would be understood by one of skill in the art upon reading the present descriptions.

Each of the steps of the method 200 may be performed by any suitable component of the operating environment. For example, in various embodiments, the method 200 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that, in some approaches, method 200 may be performed on a software document other type that would become apparent to one of ordinary skill in the art after reading the descriptions herein. Various operations below and herein may be described from the operational perspective of a single software document, in some other approaches, method 200 may be performed on a plurality of software documents, e.g., sequentially and/or in parallel, and/or may be performed on the same software document over a plurality of iterations over time. Furthermore, in some approaches, method 200 may be performed by a computer device that has artificial intelligence (AI) features enabled thereon, which may be of a type that would become apparent to one of ordinary skill in the art after reading the descriptions herein.

Furthermore, it may be prefaced that the operations of method 200 enable an automated validation and testing of software documentation associated with a codebase. More specifically, these operations enable the testing of an embedded example in a graphical user interface documentation by creating an extractable embedded example. This example is, in some preferred approaches, created by tagging the embedded example, extracting the extractable embedded example from the graphical user interface documentation to generate an extracted example, selecting a tagged entity from the extracted example, interpreting the tagged entity to generate an interpreted tagged entity, creating a test suite using the interpreted tagged entity, selecting a graphical tool against which to execute the test suite, executing the test suite against the graphical tool to generate an output response, and verifying the output response.

Method 200 preferably includes validating code blocks in a software document by performing a first validation process. In some approaches, the first validation process is performed in response to a determination that a trigger event has occurred. The trigger event is preferably associated with an activity that occurs with respect to the software document. For example, in some approaches, the trigger event is based on a development platform release, e.g., a determination that a github development platform has a scheduled release, receiving notice that a development platform is developing a development platform, receiving the development platform release, etc. Another trigger event includes a product release, in some approaches. This product may be an initial product release, or in some other approaches, be an update to an existing product. In yet some other approaches, the trigger event may be a manual request. For example, a request to perform the first validation process may be received from a user device that is planning to use the software document. In other words, before the user device uses the software document, the user device may request that the most recent version of the software document be verified first.

In order to determine whether one or more of the trigger events described above have occurred, in some approaches, monitoring may be performed for changes made to the software document, e.g., see decision 202. In response to a determination that such trigger events have not caused changes to the software document, e.g., as illustrated by the “NO” logical path of decision 202, monitoring optionally continues. In contrast, in response to a determination that such trigger events have caused changes to the software document, e.g., as illustrated by the “YES” logical path of decision 202, method 200 optionally continues to operation 204.

Various operations for performing the first validation process are described below.

The first validation process, in some approaches, includes iterating through lines in the software document to identify the code block(s) of the software document. This iterating may, in some approaches, begin with a first considered line in the software document, e.g., see operation 204 which includes parsing a first line in the software document. This parsing may optionally continue until a determination is made that an end of a code block has been reached. This way, an entirety of the code block is identified, rather than only a portion of the code block. Various operations for determining the entirety of the code block are described below.

Decision 206 of method 200 includes determining whether a currently considered line in the software document, e.g., the first line in the software document, indicates the start of a code block to execute. Such a determination may, in some approaches, be made based on whether the first line in the software document includes a predetermined type of function, call, language, etc. In response to a determination that the currently considered line of the software document does not indicate the start of a code block to execute, e.g., as illustrated by the “NO” logical path of decision 206, the line of the software document is ignored, e.g., see operation 212. In contrast, in response to a determination that the currently considered line of the software document indicates the start of a code block to execute, e.g., as illustrated by the “YES” logical path of decision 206, a next line of the software document is considered, e.g., see operation 208. For context, this advancement to the next line of the software document is performed in order to eventually identify an end of the code block, e.g., a close of the code block. Accordingly, a determination may be performed that includes determining whether the next line of the software document indicates the close of the code block that will be executed, e.g., see decision 210. In some approaches, a determination is made that the next line of the software document indicates the close of the code block based on the next line of the software document including a predetermined type of command and/or notation, e.g., “end”.

In response to a determination that the next line of the software document indicates the close of the code block, e.g., as illustrated by the “YES” logical path of decision 210, the identified code block, e.g., as identified by the first line to the next line determined to indicate a close of the code block, is extracted. In some approaches this extraction includes adding the next line of the software document that indicates the close of the code block to an end of a command script, e.g., see operation 214. With reference again to decision, in response to a determination that the next line of the software document does not indicate the close of the code block, e.g., as illustrated by the “NO” logical path of decision 210, the line of code is preferably ignored, e.g., see operation 212, and the method optionally continues to operation 216 in which a next line of the software document is considered. Decision 218 includes determining whether the currently considered line of the software document is a last line in the software document. In some approaches, such a determination is based on whether no subsequent line exists in the software document past the currently considered line. In response to a determination that the currently considered line is the last line in the software document, e.g., as illustrated by the “YES” logical path of decision 218, parsing of the software document ends, e.g., see operation 220. In contrast, in response to a determination that the currently considered line is not the last line in the software document, e.g., as illustrated by the “NO” logical path of decision 218, the method returns to operation 208.

The above techniques may be performed to identify and extract all of the code blocks of the software document. In some approaches, method 200 optionally includes determining an amount of a codebase that the code blocks cover, where the codebase is associated with the software document, e.g., code coverage. For context, this determination may be made in order to thereafter know what portion of the codebase generated characterizations of the code blocks correspond to. In other words, this metric may optionally be included in a generated report to indicate whether a majority of the software document is made up of code, or non-code portions. Techniques for determining code coverage that would become apparent to one of ordinary skill in the art after reading the descriptions herein may be used to perform this optional determination.

The extracted code blocks are preferably executed, e.g., see operation 222 which includes executing a command script that includes the code block(s). The code blocks are, in some preferred approaches, executed in a sandbox environment using execution techniques that would become apparent to one of ordinary skill in the art after reading the description herein.

Decision 224 includes determining whether the code blocks execute correctly. In some approaches, individual instructions used to execute the code blocks may have associated return codes. In some approaches, at least some error return codes may be ignored, e.g., be determined to not be indicative of an incorrect execution, in response to a determination that the error return codes indicate that a previous run have been successfully performed. In some other approaches, any error codes may be determined to be indicative of an incorrect execution of an associated code block. In response to a determination that at least some of the command script computes with error, e.g., as illustrated by the “NO” logical path of decision 224, an error is reported, e.g., see operation 226. For example, method 200 includes generating a report characterizing the software document. This report may include details, e.g., metadata and/or data that characterize the errors that occurred during the computing, e.g., such as the return codes. Furthermore, the generated report may, in some preferred approaches, include a static output document, and furthermore, may also include an online and updatable (dynamic) dashboard of a type that would become apparent to one of ordinary skill in the art after reading the descriptions herein. This way, the generated report enables documentation to be shown as a close to real time status, e.g., an undiscernible delay of seconds or less. In response to a determination that the command script computes without error, e.g., as illustrated by the “YES” logical path of decision 224, success of the execution of the command script is reported, e.g., indicated in the generated report (see operation 228).

The report may, in some approaches, additionally and/or alternatively include a project coverage metric that indicates the amount of the codebase that the code blocks cover, e.g., which may be determined using techniques described elsewhere above. Furthermore, in some approaches, the report may include an instruction validity metric that indicates an amount of the code blocks that executed correctly during execution of the code blocks, where the instruction validity metric is based on a validation of the code blocks.

Execution of the extracted code blocks are described above to be used for determining whether the code block portions of the software document are valid, e.g., configured to execute correctly. A quality of the writing that exists in the software document may additionally and/or alternatively be tested and incorporated into the generated report, in some approaches. For example, method 200 may include characterizing a quality of writing that exists in the software document by inputting at least some of the software document into at least one Large Language Model (LLM) and/or AI-based techniques that would become apparent to one or ordinary skill in the art after reading the descriptions herein. For context, the LLM and/or AI-based techniques are, in some approaches, configured to check content of the software document for grammatical and lexical correctness in order to generate the characterizations. Furthermore, it should be noted that at least some of the content of the software document that is checked may be content other than the code blocks and quotations of the software document. In other words, at least some of the software document input into the LLM does not include the identified code blocks, e.g., the identified code blocks are excluded from the software document input into the LLM. This content may, in some approaches, include content that is identified using natural language processing performed on the software document for identifying predetermined keywords, e.g., text following the keywords “how to” that make up instructions.

An output of the at least one LLM includes characterizations of the quality of writing that exists in the software document. This quality may be defined as one or more lucidity metric(s) in the report. For example, method 200 may include adding a lucidity metric in the generated report, where the lucidity metric indicates a readability of the software document and is based on the output of the LLM.

The generated report thereby may provide consumers/end users/authors/internal teams proof and evidence of documentation quality through execution of code and results displayed in the report. The report also serves as a relatively high quality documentation for internal projects and improve the appetite for collaboration and integration. Within the technical field of open source, the techniques described herein helps open source projects ensure that their documentation is up-to-date and that instructions are accurate. Accordingly, a use case example of the techniques described herein may include opensource or inner source maintainers that have a desire to keep their source code, releases, and documentation aligned as they continuously evolve.

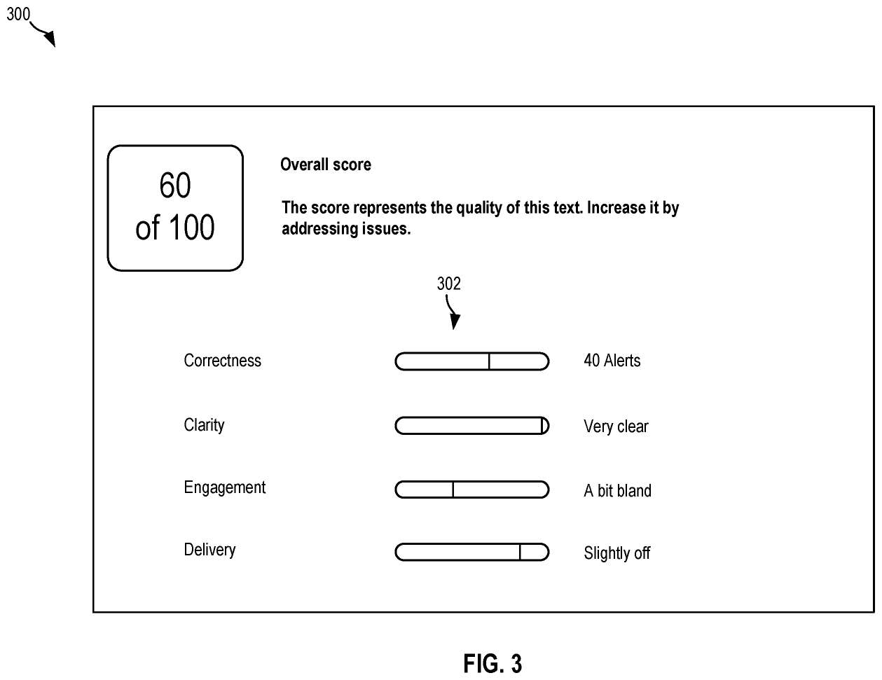

FIG. 3 depicts a generated report 300, in accordance with one embodiment. As an option, the present generated report 300 may be implemented in conjunction with features from any other embodiment listed herein, such as those described with reference to the other FIGS. Of course, however, such generated report 300 and others presented herein may be used in various applications and/or in permutations which may or may not be specifically described in the illustrative embodiments listed herein. Further, the generated report 300 presented herein may be used in any desired environment.

The generated report 300 may be generated in response to performing a validation and testing process (e.g., see operations of method 200) of a software document. In some approaches, the validation and testing process is in some approaches triggered at a milestone, e.g., github release, individual product release, manual request, etc. An LLM-based model and/or a grammar check API may be implemented for documentation text quality check. Furthermore, text/markdown keywords may be used to identify blocks of code instructions, and in response to a determination that a predetermined trigger event has occurred, the text may be run (without the identified code instructions) through the text quality checker to test for documentation lucidity. In some approaches, a sandbox is used to run the code instructions and report the status, e.g., results, of the execution may be included in a generated report, e.g., see FIG. 3. In some approaches, project/code components may be identified, and an evaluation may be performed to determine the coverage by the documentation, e.g., using a statistical code coverage tool of a type that would become apparent to one of ordinary skill in the art after reading the descriptions herein.

The generated report 300 characterizes results of testing and validating the software document using the techniques described above. This characterization serves as a visibility/reporting on results of a complete analysis of the documentation used to generate the evaluated software document. As mentioned elsewhere herein a first metric that may be included in a generated report may include a project coverage metric, e.g., see Project coverage. This metric characterizes how much of the codebase of the software document the documentation command scripts cover. An instruction validity metric, e.g., see Correctness. This metric may be based on the results of the command scripts execution with recommendations. Here the generated report details that forty alerts were detected during execution of extracted code blocks of the software document. Percentage icons 302 may characterize the relative scores of each of the metrics, e.g., with respect to a predetermined scale. A clarity metric may be output by one or more LLMs and characterize whether the software document was determined to include any ambiguous instructions, e.g., text instructions that did not correspond to any current features of the software document and/or code blocks. The generated report additionally includes document lucidity metrics, e.g., see Engagement and Delivery. These metrics may be generated by the LLMs and characterize how relatively easy the documentation is to read and understand, e.g., see “A bit bland” and “Slightly off”. Note that the percentage icons 302 associated with the lucidity metrics may be used to determine a relative severity that “A bit bland” and “Slightly off” have on a predetermined scale.

The generated report also includes an overall score, e.g., see 60 of 100, which represents a quality of the text of the evaluated software document. This score may be increased by addressing issues noted in the generated report, e.g., see Alerts. In some approaches, the overall score is generated by averaging scores determined for the metrics in the generated report. In some other approaches the overall score is a weighted average of the percentage icons, e.g., where each of the different metrics is assigned a different weight that is to be incorporated into the weighted average for the overall score.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method (CIM), the CIM comprising:
validating code blocks in a software document by performing a first validation process, wherein the first validation process includes:
iterating through lines in the software document to identify the code blocks,
extracting the identified code blocks,
determining an amount of a codebase that the code blocks cover, wherein the codebase is associated with the software document,
executing the code blocks, and
determining whether the code blocks execute correctly; and
generating a report characterizing the software document, wherein the report includes:
a project coverage metric that indicates the amount of the codebase that the code blocks cover, and
an instruction validity metric that indicates an amount of the code blocks that executed correctly during execution of the code blocks, wherein the instruction validity metric is based on a validation of the code blocks.

2. The CIM of claim 1, wherein the code blocks are executed in a sandbox environment.

3. The CIM of claim 1, comprising: characterizing a quality of writing that exists in the software document by inputting at least some of the software document into a Large Language Model (LLM).

4. The CIM of claim 3, wherein an output of the LLM includes characterizations of the quality of writing that exists in the software document.

5. The CIM of claim 4, comprising: adding a lucidity metric in the generated report, wherein the lucidity metric indicates a readability of the software document and is based on the output of the LLM.

6. The CIM of claim 5, wherein the LLM is configured to check content of the software document for grammatical and lexical correctness in order to generate the characterizations.

7. The CIM of claim 3, wherein the at least some of the software document input into the LLM does not include the identified code blocks.

8. The CIM of claim 1, wherein the first validation process is performed in response to a determination that a trigger event has occurred.

9. The CIM of claim 8, wherein the trigger event is selected from the group consisting of: a development platform release, a product release, and a manual request.

10. A computer program product (CPP), the CPP comprising:
a set of one or more computer-readable storage media; and
program instructions, collectively stored in the set of one or more storage media, for causing a processor set to perform the following computer operations:
validate code blocks in a software document by performing a first validation process, wherein the first validation process includes:
iterating through lines in the software document to identify the code blocks,
extracting the identified code blocks,
determining an amount of a codebase that the code blocks cover, wherein the codebase is associated with the software document,
executing the code blocks, and
determining whether the code blocks execute correctly; and
generate a report characterizing the software document, wherein the report includes:
a project coverage metric that indicates the amount of the codebase that the code blocks cover, and
an instruction validity metric that indicates an amount of the code blocks that executed correctly during execution of the code blocks,
wherein the instruction validity metric is based on a validation of the code blocks.

11. The CPP of claim 10, wherein the code blocks are executed in a sandbox environment.

12. The CPP of claim 10, the CPP comprising: program instructions, collectively stored in the set of one or more storage media, for causing the processor set to perform the following computer operations: characterize a quality of writing that exists in the software document by inputting at least some of the software document into a Large Language Model (LLM).

13. The CPP of claim 12, wherein an output of the LLM includes characterizations of the quality of writing that exists in the software document.

14. The CPP of claim 13, the CPP comprising: program instructions, collectively stored in the set of one or more storage media, for causing the processor set to perform the following computer operations: add a lucidity metric in the generated report, wherein the lucidity metric indicates a readability of the software document and is based on the output of the LLM.

15. The CPP of claim 14, wherein the LLM is configured to check content of the software document for grammatical and lexical correctness in order to generate the characterizations.

16. The CPP of claim 12, wherein the at least some of the software document input into the LLM does not include the identified code blocks.

17. The CPP of claim 10, wherein the first validation process is performed in response to a determination that a trigger event has occurred.

18. The CPP of claim 17, wherein the trigger event is selected from the group consisting of: a development platform release, a product release, and a manual request.

19. A computer system (CS), the CS comprising:
a processor set;
a set of one or more computer-readable storage media;
program instructions, collectively stored in the set of one or more storage media, for causing the processor set to perform the following computer operations:
validate code blocks in a software document by performing a first validation process, wherein the first validation process includes:
iterating through lines in the software document to identify the code blocks,
extracting the identified code blocks,
determining an amount of a codebase that the code blocks cover, wherein the codebase is associated with the software document,
executing the code blocks, and
determining whether the code blocks execute correctly; and
generate a report characterizing the software document, wherein the report includes:
a project coverage metric that indicates the amount of the codebase that the code blocks cover, and
an instruction validity metric that indicates an amount of the code blocks that executed correctly during execution of the code blocks, wherein the instruction validity metric is based on a validation of the code blocks.

20. The CS of claim 19, wherein the code blocks are executed in a sandbox environment.
